(19) United States
(12) Patent Application Publication
(10) Pub. No.: US 2002/0110795 A1
(43) Pub. Date: Aug. 15, 2002

(54) Method of conducting continuing education programs

(76) Inventor: Marc Lemchen, New York, NY (US)

Correspondence Address: Daniel L. Dawes, MYERS, DAWES & ANDRAS LLP, Suite 1150, 19900 MacArthur Boulevard, Irvine, CA, 92612, US

(21) Appl. No.: 09/780,871

(22) Filed: Feb. 9, 2001

(51) Int. Cl. G09B 3/00

(52) U.S. Cl. 434/350

(57) ABSTRACT

An on-line continuing education course is conducted by a web server. A user takes the on-line course and may stop at any point during the course. The server keeps an account of the user's journey through the course by saving the exact position where the user left. Depending upon the course of instruction, the user could be credited for a partially completed course with fractional credits if so stated in the course description. Thus, the user may resume the course at any subsequent time and the server will take the user to the exact point where he left off. The server also keeps a record of the number of correct answers the user may have scored, and, thus, any credit he may have already earned in a prior session of the same course.

Informational “bites” and full courses can be easily presented in a news format, similar to on line news services, thereby making continuing education necessary to maintain a certified professional status as easy to read and use as a conventional newspaper.

### BACKGROUND OF THE INVENTION

1. Field of the Invention

The invention relates generally to internet or on-line continuing education activities.

2. Description of Related Art

Various professions require their members to maintain a minimum standard of knowledge and awareness relating to issues in their respective field by fulfilling continuing education requirements. These requirements are typically satisfied by attending an event, performing self-study activities, or completing a program on the Internet.

Members of such professions, including the legal, medical, and financial professions, typically have busy schedules that leave them little flexibility for doing any activity in an extended, uninterrupted period of time. Though self-study activities may be performed according to a member's own schedule, the regulating authorities for such professions typically limit the amount of credit a member can receive for self-study. Moreover, most self-study assignments still require a block of uninterrupted time of an hour or more to satisfactorily complete.

### BRIEF SUMMARY

An on-line continuing education course or activity is provided according to the invention wherein a user may take the course in multiple short portions or “information bites”. In other words, the continuing education assignment is divided into 1-15 minute segments with a question or questions at the end of each 1-15 minute segment to verify completion and understanding. An educational “bite” could only be a 1-15 minute segment, rewarding the user, upon answering a following question with a fraction of a continuing educational credit, which is then added to other similarly earned fractional credits at other times to build a full credit. A web server keeps an account of the user's participation and progress through a longer assignment and activity, recording the position within the assignment at which the user logs off a program and later returns the user to the on-line activity at the same position within the assignment. The server also records any correct answers and any corresponding continuing education credits earned in previous sessions of the same course. At the end of a successful completion of the assignment the program records the completion, sends or emails a certificate of completion for printing, and may also emails a copy to the appropriate accrediting organization.

In summary, an on-line continuing education course is conducted by a web server. A user takes the on-line course and may stop at any point during the course. The server keeps an account of the user's progress through the course by saving the exact position where the user left. Thus, the user may resume the course at any subsequent time and the server will take the user to the exact point where he left off. The server also keeps a record of the number of correct answers the user may have scored, and, thus, any credit he may have already earned in a prior session of the same course.

The invention can be better visualized by turning to the following drawings.

### BRIEF DESCRIPTION OF THE DRAWINGS

FIG. 1 is a simplified block diagram of an illustrative system in which the invention may be performed. It is to be expressly understood that many other organizations of a computer system for performing the invention can be substituted with departing from the scope of the invention.

FIG. 2 is a simplified flow diagram which illustrates the method of the invention. Again it is to be expressly understood that many other formats for the method of the invention can be substituted with departing from the scope of the invention.

The invention can now be better understood by turning to the illustrated embodiment described in the Detailed Description Of The Preferred Embodiments.

### DETAILED DESCRIPTION OF THE PREFERRED EMBODIMENTS

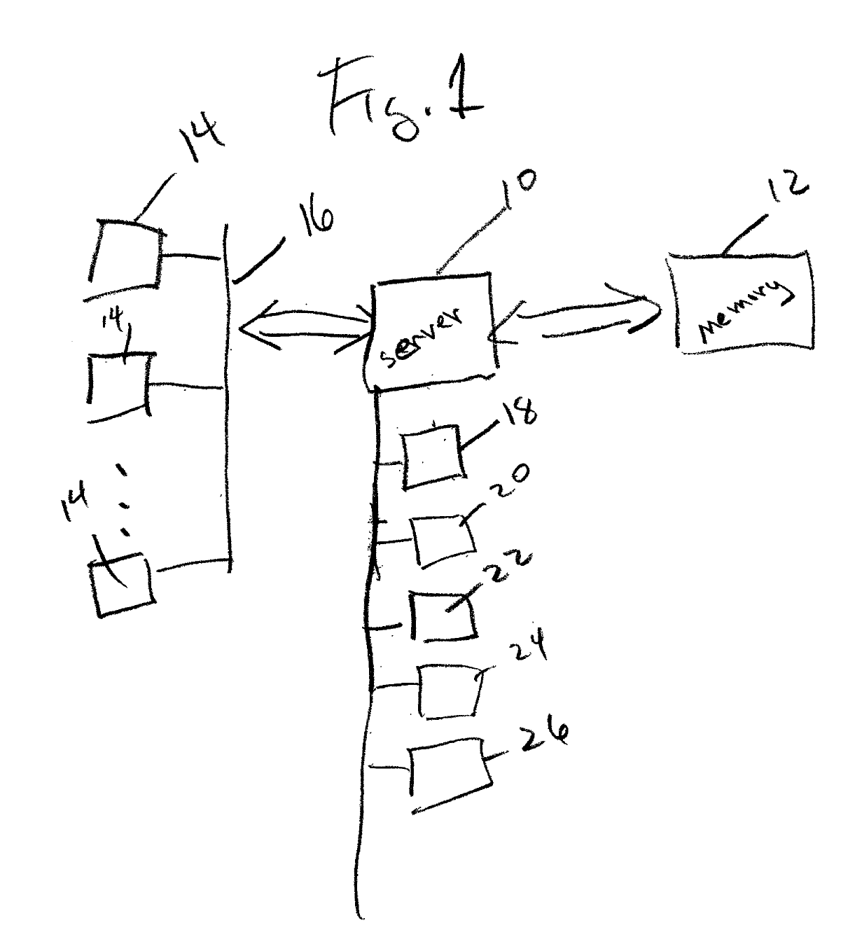

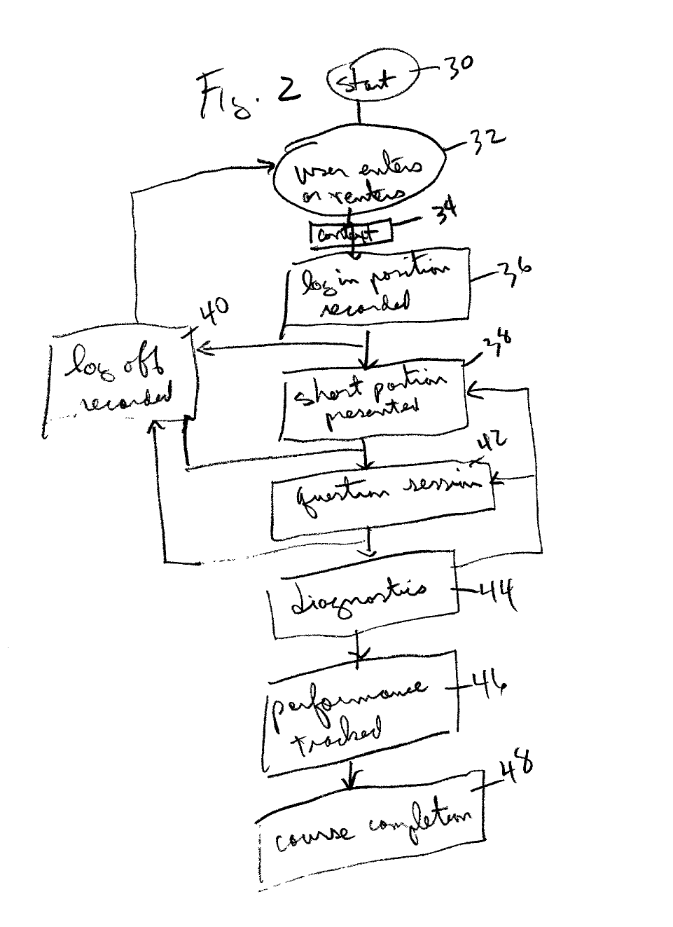

A method is provided for fulfilling continuing education (“CE”) requirements on the Internet in small information steps or bites as shown in the simplified diagram of FIG. 2. The invention illustrates the proverb that a 1000 mile journey begins with a single step. A web server 10 shown in FIG. 1 which hosts a web-site wherein a plurality of clients or users 14 can enter server 10 via the Internet 16 to take a CE course or activity on-line as shown at step 30 in FIG. 2. The user 14 enters the web-site of server 10 with his or her own computer via the Internet 16. The course or courses of instruction stored in memory 12 coupled to server 10 comprises a variety of different on-line activities which allow a user to receive credit to satisfy the CE requirements. The course of instruction may include portions which contain textual, graphic or audiovisual information as well as questions directed to the information which the user must answer. The web server 10 by means of a user's performance controller 18 keeps an account of the number of correct answers the user 14 has entered. Various scoring formats may be used to give the user credit depending on the number of correct answers made.

The information is provided by server 10 in small units or “information bites” which can be viewed and understood in a short period of time, as short as 15-30 seconds or a few minutes. This allows the user 14 to use miscellaneous moments between other working tasks to progress in a logical manner through a much longer course. Hypertext links are provided by server 10 in each information bite to allow for quick recourse to earlier definitions, concepts or facts which may not have been remembered, but which are required to successfully complete the information bite. A following question may also include diagnostics if answered incorrectly provided by a user's diagnostic controller 20. Thus, if the answer is wrong either a set diagnostic is displayed for common or anticipated errors or a plain language search diagnostic is provided by user's diagnostic controller 20 to allow the user 14 to explain in simple terms what he did not understand about the question. The question is parsed by user's diagnostic controller 20 and linked back to portions of the assignment which may provide the information which the user 14 stated that he does not understand or remember.

In addition, upon each reentry into the system, the user is provided by a user's context controller 22 with an conceptual outline of concepts with links which have been presented and completed in the assignment up to the point of the user's position. These types of aids are provided, since it is understood that the user will not be maintaining a continuous train of thought in working through the assignment, but will be returning out of context on multiple occasions to pick up incremental additional units of information and ideas. Thus, the context of each information bite is clearly presented by user's context controller 22 on each occasion for refreshment of recollection and speed in assimilating the new information provided in the new information bite.

The web server 10 keeps an account of the user's journey through the on-line course by means of a user's accounting controller 24 and enables the user 14 to stop at any time during the course, whether the user 14 decides to stop reading at an information portion of the course or stop answering questions at the examination portion. The method comprises allowing the user to return to the web-site by means of a user's record controller 26 and, in particular, to the same on-line course, and to resume at the precisely the point where he or she left off.

In the preferred embodiment, the user may, for instance, stop after having answered three questions and log off the web-site. The server 10 by means of user's record controller 26 not only saves the exact virtual position at which the user was disposed when logging off, but also keeps an account of the number of correct answers given by user's performance controller 18. Thus, the user 14 can return to the on-line course at any subsequent time and resume taking the course with his prior score still accounted for.

Once the entire course is completed, the user 14 will receive all earned credits and an acknowledgement that he has completed the course by means of user's accounting controller 24. The acknowledgment comprises various forms, including certificates and other documents which may be electronically forwarded by user's accounting controller 24 to the user 14.

It will be appreciated that the user 14 need not sit through an entire on-line course uninterrupted. The user 14 may take the course in fragmented portions depending upon his or her own personal schedule without sacrificing any credit earned during an earlier session.

For example in one embodiment of the method as shown in FIG. 2, user 14 enters the website at step 30 and logs in a position at step 32. If user 14 has previously logged in he may be automatically logged in at the position where he left off or may be given the option to log in at an arbitrarily selected position. The contextual outline of where user 14 is at the entry time is provided at step 34. Thus, in one of these modes the chosen log in position is recorded at step 36. The next short portion of the course is presented at step 38 or user 14 may choose to immediately log off at step 40 where his log off position is then recorded for the next entry. After presentation of the short portion at step 38, a question session is presented and completed at step 42. It must be understood that log off to step 40 is permitted at any time including during steps 38 and 42 or any other steps. Once a question or questions are answered one or more of the diagnostic schemes described above are performed at step 44. Again the diagnostic steps may be performed after each question or may be performed after a group of questions according to course design and/or user discretion. The user's cumulative and current performance is tracked at step 46. When the course is completed, or any defined subunit of the course is completed, a corresponding report or certificate is automatically generated at step 48 and sent to user 14 via the internet and/or to an accreditation organization.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention which could be more broadly or narrowly defined later by patent claims.

For example, while FIG. 1 illustrates an organization involving a server 14 and separate controllers, it must be understood that the controllers described above may be software modules in a general purpose programmable computer and not actual separate circuits or logic controllers. The functions described may also be provided by a differently organized set of software modules than those described. For example, single modules described above may be broken down into different submodules with different hierarchies or may be combined with each other into different super-modules again with different hierarchies than that illustrated.

The words used in this specification to describe the invention, and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in later in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in later defined claims or that a single element may be substituted for two or more elements in later defined claims.

Insubstantial changes from the claimed subject matter as viewed by a person with ordinary skill in the art, now known or later devised, are expressly contemplated as being equivalently within the scope of the invention. Therefore, obvious substitutions now or later known to one with ordinary skill in the art are defined to be within the scope of the defined elements.

The invention is thus to be understood to include what is specifically illustrated and described above, what is conceptionally equivalent, what can be obviously substituted and also what essentially incorporates the essential idea of the invention.

I claim:

1. A method of providing on-line continuing education through a server coupled to a computer network serving a plurality of users comprising:
providing multiple short portions of a course of instruction in a server;
providing a question session corresponding to each of said multiple short portions of a course of instruction to verify completion and understanding in said server;
accounting for each user's participation and progress through said course of instruction;
recording a log-off position within an assignment at which each said user logs off;
returning said user to said course of instruction at the said log-off position within said course of instruction;
recording any correct answers and any corresponding continuing education credits earned in previous sessions of said course of instruction for each user; and
determining successful completion of said course of instruction; sending a certificate of completion.

2. The method of claim 1 further comprising sending a copy of said certificate of completion to a selected accrediting organization.

3. The method of claim 1 where providing said short portions provides instructional segments approximately 1-15 minute in length.

4. The method of claim 1 where said computer network is the internet and where said method is performed at least in part in communicating over said internet.

5. The method of claim 1 where recording a log-off position within an assignment at which each said user logs off is at an arbitrary point during said course of instruction.

6. The method of claim 5 where returning said user to said course of instruction at the said log-off position is at the exact position where the user logged off.

7. The method of claim 1 where providing multiple short portions of a course of instruction in a server provides textual, graphic or audiovisual information as well as questions directed to the information which said user must answer.

8. The method of claim 1 where providing multiple short portions of a course of instruction in a server provides information in units which on the average can be viewed and understood in a 1-6 minutes or less.

9. The method of claim 8 where providing information comprises providing said information in units which on the average can be viewed and understood in a 30 seconds or less.

10. The method of claim 1 where providing multiple short portions of a course of instruction in a server comprises also providing hypertext links in each short portion to allow for recourse to earlier definitions, concepts or facts which may not have been remembered, but which are required to successfully complete said short portion.

11. The method of claim 1 further comprising providing a diagnostics unit if a question in said question session is answered incorrectly.

12. The method of claim 11 where, if an answer to a question in said question session is wrong, providing a set diagnostic is displayed for common or anticipated errors.

13. The method of claim 11 where, if an answer to a question in said question session is wrong, providing a plain language search diagnostic to allow each said user to explain what is not understand about said question, parsing said explanation of said user to link back to said short portions of said course of instruction which may provide information which each user stated is not understood or remembered.

14. The method of claim 1 further comprising providing each user upon each reentry into said course of instruction a conceptual outline of concepts with links which have been presented and completed in said course of instruction up to the point of each user's in position said course of instruction, so that the context of each information unit is clearly presented on each occasion for refreshment of recollection and to speed in assimilating the new information provided in each new information unit.

15. An apparatus of providing on-line continuing education to a computer network serving a plurality of users comprising:
a server coupled to said network;
a memory coupled to said server in which multiple short portions of a course of instruction are stored and a question session corresponding to each of said multiple short portions of a course of instruction to verify completion and understanding in said server;
a user's accounting controller to track for each user's participation and progress through said course of instruction, to determine successful completion of said course of instruction, and to send a certificate of completion;
a user's record controller to record a log-off position within an assignment at which each said user logs off and to return said user to said course of instruction at the said log-off position within said course of instruction; and
a user's performance controller to record any correct answers and any corresponding continuing education credits earned in previous sessions of said course of instruction for each user.

16. The apparatus of claim 15 where said user's accounting controller sends a copy of said certificate of completion to a selected accrediting organization.

17. The apparatus of claim 15 where said server provides short portions approximately 1-15 minute instructional units.

18. The apparatus of claim 15 where said computer network is the internet and where said apparatus is performed at least in part in communicating over said internet.

19. The apparatus of claim 15 where said user's record controller records a log-off position within an assignment at which each said user logs off is at an arbitrary point during said course of instruction.

20. The apparatus of claim 19 where said user's record controller returns said user to said course of instruction at the said log-off position is at the exact position where the user logged off.

21. The apparatus of claim 15 where said server provides multiple short portions of a course of instruction in a server provides textual, graphic or audiovisual information as well as questions directed to the information which said user must answer.

22. The apparatus of claim 15 where said server provides multiple short portions of a course of instruction in a server provides information in units which on the average can be viewed and understood in a 1-6 minutes or less.

23. The apparatus of claim 22 where said server provides information in units which on the average can be viewed and understood in a 30 seconds or less.

24. The apparatus of claim 15 where said server provides hypertext links in each short portion to allow for recourse to earlier definitions, concepts or facts which may not have been remembered, but which are required to successfully complete said short portion.

25. The apparatus of claim 15 further comprising a user's diagnostic controller to provide a diagnostics unit if a question in said question session is answered incorrectly.

26. The apparatus of claim 25 where, if an answer to a question in said question session is wrong, said user's diagnostic controller provides a set diagnostic which displays common or anticipated errors.

27. The apparatus of claim 25 where, if an answer to a question in said question session is wrong, said user's diagnostic controller provides a plain language search diagnostic to allow each said user to explain what is not understand about said question, which diagnostic parses said explanation of said user to link back to said short portions of said course of instruction which may provide information which each user stated is not understood or remembered.

28. The apparatus of claim 15 further comprising a user's context controller to provide each user upon each reentry into said course of instruction a conceptual outline of concepts with links which have been presented and completed in said course of instruction up to the point of each user's in position said course of instruction, so that the context of each information unit is clearly presented on each occasion for refreshment of recollection and to speed in assimilating the new information provided in each new information unit.

29. A method of providing on-line continuing education through a server coupled to a computer network serving a plurality of users comprising:
providing multiple 1-15 minute portions of a course of instruction in a server;
providing a question session corresponding to each of said multiple 1-15 minute portions of a course of instruction to verify completion and understanding in said server;
accounting for each user's participation and progress through said course of instruction by fractional credits of completion of said course of instruction; and
accumulating said fractional credits for acknowledgement of at least partial successful completion of said course of instruction.
